(19) United States
(12) Patent Application Publication
(10) Pub. No.: US 2005/0270413 A1
(43) Pub. Date: Dec. 8, 2005

(54) Adjustment of illumination light quantity for moving picture in moving picture image pickup device

(75) Inventors: Toshinobu Hatano, Kyoto (JP); Michiko Morita, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/143,582

(22) Filed: Jun. 3, 2005

(30) Foreign Application Priority Data
Jun. 8, 2004 (JP) P2004-169682

(51) Int. Cl. H04N 5/222; H04N 9/74

(52) U.S. Cl. 348/370

(57) ABSTRACT

The moving picture image pickup device of the present invention comprises: a lighting device for performing lighting operation in response to an input of an illumination control pulse; a signal processing unit for calculating luminance of an object based on a signal from an image sensor; and a control unit for adjusting illumination light quantity of the lighting device according to the luminance of the object calculated by the signal processing unit, wherein the control unit changes the luminance of the object in real time by performing feedback control on the illumination light quantity of the lighting device through adjusting pulse width of the illumination control pulse in accordance with the luminance of the object.

### BACKGROUND OF THE INVENTION

1. Field of the Invention

The present invention relates to a moving picture image pickup device such as a digital camera and, more specifically, to a lighting technique for moving pictures when picking up moving objects under environments with low illumination.

2. Description of the Related Art

Recently, there has been a striking transition of technology in the field of camera from analog to digital. Particularly, digital still cameras which require neither film nor developing have been active on the market, and portable telephones with a built-in camera have become the mainstream.

At present, CCD-type image sensors are the mainstream of the image sensors for digital cameras. However, properties of MOS-type sensors have improved and attracted attentions as the image sensors to replace the CCD-type image sensors. More improved high-performance is required for the image sensors and also a development in a technology for achieving extremely small and high-sensitive pixels is desired for achieving size reduction.

A current digital camera uses a halogen lamp and a light emitting diode as a lighting device for picking up pictures under a low-illuminated environment, which is controlled through an ON/OFF switch from a CPU.

Japanese Patent Unexamined Publication No. 6-105203 and Japanese Patent Unexamined Publication No. 2000-196950 disclose the lighting technique for the digital cameras.

FIG. 6 is a block diagram for showing the basic configuration of a digital camera. In FIG. 6, numeral reference 401 is an image sensor, 402 is a timing generator for generating drive pulses for driving the image sensor 401, 403 is a CDS/AGC circuit which eliminates noise from the output signal of the image sensor 401 by correlated double sampling and automatically controls gain of the output signal, 404 is an analog-digital converter (ADC) for performing analog-digital conversion, 405 is a digital-signal-processor (DSP) for processing the digital signals from the analog-digital converter 404, 406 is a memory for storing image data and various types of data, 407 is a microcomputer (CPU) for controlling the camera, and 408 is a lighting device for lighting an object when the illuminance for the object is insufficient.

Operation will be described.

An optical image of the object forms an image on the image sensor 401 through an imaging lens. The formed optical image is converted into an electric signal by the image sensor 401 and outputted as an image signal by vertical and horizontal drive pulses from the timing generator 402. After eliminating the noise and controlling the gains by the CDS/AGC circuit 403, the analog image signal outputted from the image sensor 401 is converted into the digital image signal by the A/D converter 404. The digital image signal receives various types of signal processing such as color separation, color-matrix processing, luminance processing, etc. in the DSP 405.

In the above-described operation, under a low-illumination condition where the illuminance is insufficient for the object, the microcomputer 407 lights up the objects by continuously driving to light up the lighting device 408 such as high-luminance lamp and the like (LED, etc) by a illumination control signal.

However, in the related art, the microcomputer 407 controls lighting of the lighting device 408 regardless of the degree of luminance for the object so that there may be a short supply of lighting for the object. For example, as shown in FIG. 7, lighting permission signal 1 (illumination control signal of the microcomputer 407), which permits lighting of the lighting device 408, becomes high-level over a plurality of vertical synchronous signals (frames) for continuously lighting the lighting device 408 and lighting permission signal 2 becomes low-level for continuously putting off the lighting device 408. Thus, in the conventional lighting technique, adjustment of the illumination light quantity from the lighting device 408 for lighting the moving object is not performed when it is continuously lit.

More specifically, in the conventional lighting technique, the illumination light quantity from the lighting device is always constant regardless of the brightness of the object. Since it is the continuous lighting over the frames with a certain amount of illumination light quantity even when the environment for picking up moving picture is in a dark place and the like, when the illuminance from the lighting device alone is not sufficient, adjustment of AGC gain is performed by the signal processing for the image signal or exposure is performed over a plurality of frame rates by low-speed shuttering for improving the imaging sensitivity. However, with such adjustment of the imaging sensitivity, SN ratio deterioration may be generated in the moving picture of the object and it is difficult to attain smooth moving pictures.

### SUMMARY OF THE INVENTION

The moving picture image pickup device of the present invention comprises: an image sensor for outputting an image signal by photoelectric-converting an incident object light; a lighting device for lighting an object, whose illumination light quantity is adjustable; a signal processing unit for computing luminance of the object based on the image signal; and a control unit for adjusting illumination light quantity of the lighting device by controlling light-up state of the lighting device in accordance with the luminance of the object.

In the present invention, the illumination light quantity for the object can be adjusted in accordance with the luminance of the object. For example, the illumination light quantity can be increased when the luminance of the object changes low, and the illumination light quantity can be decreased when the luminance of the object changes high. Thus, unlike the conventional lighting technique, it enables to pick up high-quality moving pictures by appropriately lighting the object.

Preferably, the lighting device starts lighting operation by lighting up in response to an input of an illumination control pulse and also continues the lighting operation while receiving the input of the illumination control pulse; and the control unit inputs the illumination control pulse to the lighting device and also adjusts illumination light quantity of the lighting device through controlling pulse width of the illumination control pulse.

Preferably, the control unit adjusts lighting start timing and lighting end timing of the lighting device by controlling each position of a leading edge and a trailing edge of the illumination control pulse.

Preferably, pulse width of the illumination control pulse is set in one frame in between vertical synchronous signals.

### BRIEF DESCRIPTION OF THE DRAWINGS

The present invention is illustrated be way of example and not limitation in the figures of the accompanying drawings, in which like references indicate similar elements and in which:

FIG. 1 is a block diagram of a moving picture image pickup device according to a preferred embodiment of the present invention;

FIG. 2 is a block diagram of a lighting device shown in FIG. 1;

FIG. 3 is a timing chart for describing lighting operation of the lighting device shown in FIG. 1;

FIG. 4 is a graph for showing the relation between the rise time (lighting time) of the illumination control pulse and the total illumination light quantity of the lighting device shown in FIG. 1;

FIG. 5 is a graph for showing the relation between the lamp current quantity of a lighting lamp and the total illumination light quantity of the lighting device shown in FIG. 1;

FIG. 6 is a block diagram of a conventional moving picture image pickup device; and

FIG. 7 is a timing chart for describing lighting operation of the lighting device shown in FIG. 6.

### DETAILED DESCRIPTION OF PREFERRED EMBODIMENTS OF THE INVENTION

In the followings, the moving picture image pickup device according to a preferred embodiment of the preset invention will be described in detail by referring to the accompanying drawings.

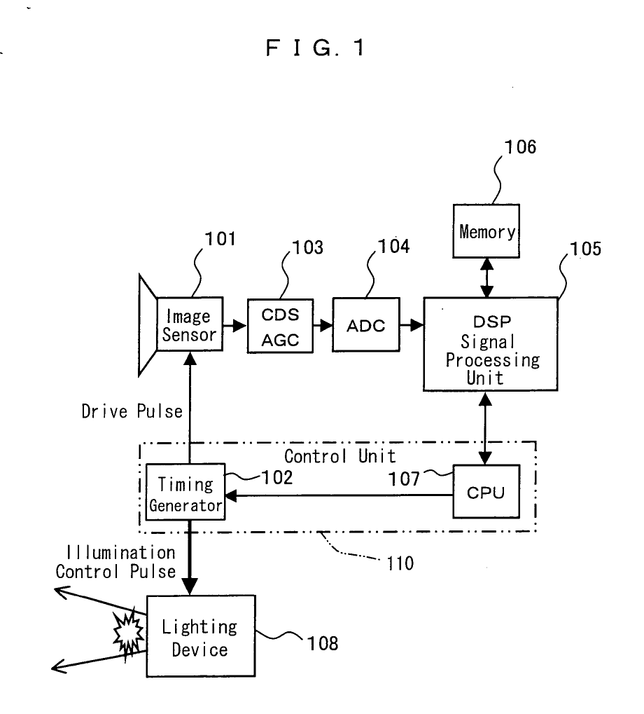

FIG. 1 is a block diagram of the moving picture image pickup device such as a digital camera according to the embodiment of the present invention. In FIG. 1, an image sensor 101 is constituted of a CCD sensor or MOS sensor which converts an object light into an image signal. The image signal is an analog image signal. A timing generator 102 outputs to the image sensor a drive pulse for driving the image senor 101. The timing generator 102 outputs to a lighting device 108 an illumination control pulse for controlling lighting operation of the lighting device 108 when picking up moving picture. The illumination control pulse is a pulse for controlling a lighting start timing and a lighting end timing of the lighting device 108. The rise of the illumination control pulse is the lighting start timing, the fall is the lighting end timing, and the pulse width corresponds to the lighting time. The illumination control pulse is generated synchronizing with the vertical synchronous signal since it is the lighting for moving pictures. The timing generator 102 can change the pulse width of the illumination control pulse for appropriately lighting the object in accordance with a scene of moving picture taken. A CDS/AGC circuit 103 is a circuit comprising a combination of a correlated double sampling (CDS) circuit for eliminating noise contained in the analog image signal outputted from the image sensor 101 and an automatic gain control (AGC) circuit for automatically controlling the output gain of the image sensor 101. An AD converter (ADC) 104 converts the analog image signal outputted from the image sensor 101 into the digital image signal. A digital signal processing circuit (DSP) 105 is a circuit for processing the digital signal. A memory 106 stores the image data and various types of data. A control unit 110 is constituted of a microcomputer (CPU) 107 and the timing generator 102. The CPU 107 is for controlling the entire system of the moving picture image pickup device, and the control includes the control of illumination light quantity of the lighting device 108. The CPU 107 has a built-in program for lighting the moving picture and a person taking pictures, etc. can set it appropriately according to the current scene by an external operation. For example, the pulse width, the rise timing, fall timing, etc. of the illumination control pulse in one frame can be set in the program. Furthermore, in addition to performing lighting control by the illumination control pulse by every frame, it may be performed by skipping every one frame.

In the control unit 110, the timing generator 102 can be omitted by giving the function of the timing generator 102 to the CPU 107. The lighting device 108 is a device which emits illumination light at the time of low-illuminance, backlight, or other circumstances which require lighting.

The object light made incident to the image sensor 101 is converted into the analog image signal by photodiodes in the image sensor 101 and is outputted by being driven vertically and horizontally in response to the drive pulse from the timing generator 102. The analog image signal outputted from the image sensor 101 receives the noise eliminating processing and gain control processing performed by the CDS/AGC circuit 103, and is converted into the digital image signal in the A/D converter 104 to be outputted to the DSP 105. Color separation, color-matrix processing, luminance processing and the like are performed on the digital image signal inputted to the DSP 105 through the memory 106. The DSP 105 further calculates luminance of the entire pixels of the image sensor 101 based on the digital image signal and inputs the calculation result to the CPU 107 of the control unit 110 as the luminance of the object. The luminance of the object is the degree of brightness of the picked up image of the object.

The CPU 107 compares the actual luminance calculated by the DSP 105 (preferably, the average of luminance) and the target luminance. The target luminance is determined arbitrarily depending on the scenes taken. For example, there may be cases where it is desired to set the image of the object bright or to set it dark depending on the occasions. Thus, unlike the conventional case in which the lighting device lights up always at a constant brightness simply at a dark place regardless of the scenes taken, it is possible to control the brightness in accordance with the scenes thereby expanding application of the device for picking up moving pictures.

In the manner as described above, data of the difference between the average luminance and the target luminance is inputted to the timing generator 102. The timing generator 102 inputs the illumination control pulse according to the luminance-difference data. When the average luminance is smaller than the target luminance, the pulse width of the illumination control pulse (lighting time in one frame) is widened. When the average luminance is larger than the target luminance, the pulse width of the illumination control pulse is narrowed. The adjustments of the pulse width of the illumination control pulse are performed by adjusting each position of the leading edge and trailing edge of the illumination control pulse. This positional adjustment does not simply control the pulse width of the illumination control pulse but also determines which area of the imaging screen to be brightened. Thus, it enables to attain plenty of variations of the scene by changing the lighting.

The timing generator 102 has a register for respectively setting the positions of the leading edge and trailing edge of the illumination control pulse. The CPU 107 adjusts the set values of the positions for the register of the timing generator 102 according to the difference-luminance data of the average luminance and the target luminance. In other words, the set values of the positions in the register of the timing generator 102 are rewritten according to the brightness of the object. Thereby, the pulse width of the illumination control pulse of the timing generator 102 is adjusted.

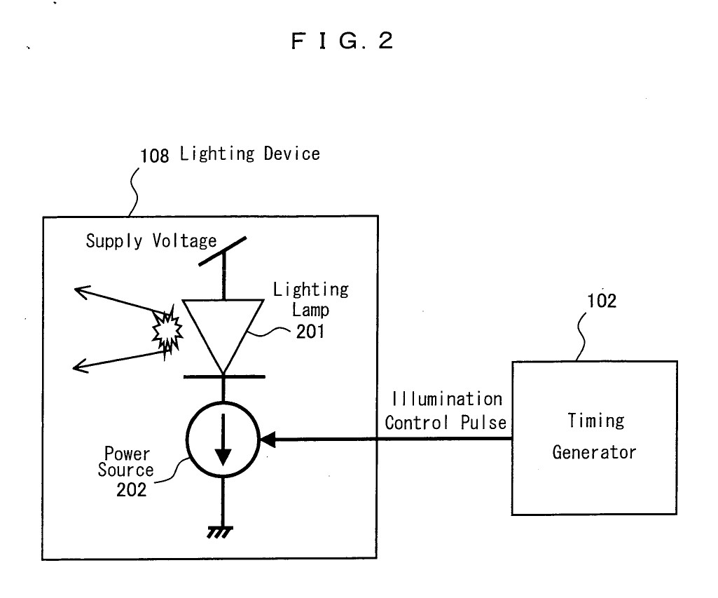

FIG. 2 shows the lighting device 108 and the timing generator 102. The lighting device 108 comprises: a lighting lamp 210, whose illumination light quantity change according to the current quantity; and a current-quantity variable current generator 202 which can variably control ON/OFF and the quantity of the lamp current flown to the lighting lamp 201. The lighting lamp 201 is constituted of a light emitting diode (LED). The current-quantity variable current generator 202 is controlled by the illumination control pulse from the timing generator 102.

Upon judging that the average luminance is smaller than the target luminance and the brightness of the object is low, the CPU 107 widens the pulse width of the illumination control pulse of the timing generator 102. As a result, the lighting time of the lighting lamp 201 is extended through the control of the current-quantity variable current generator 202 and the illumination light quantity of the lighting lamp 201 for the object is increased.

Upon judging that the average luminance is smaller than the target luminance and the brightness of the object is high, the CPU 107 narrows the pulse width of the illumination control pulse of the timing generator 102. As a result, the lighting time of the lighting lamp 201 is shortened through the control of the current-quantity variable current generator 202 and the illumination light quantity of the lighting lamp 201 for the object is decreased.

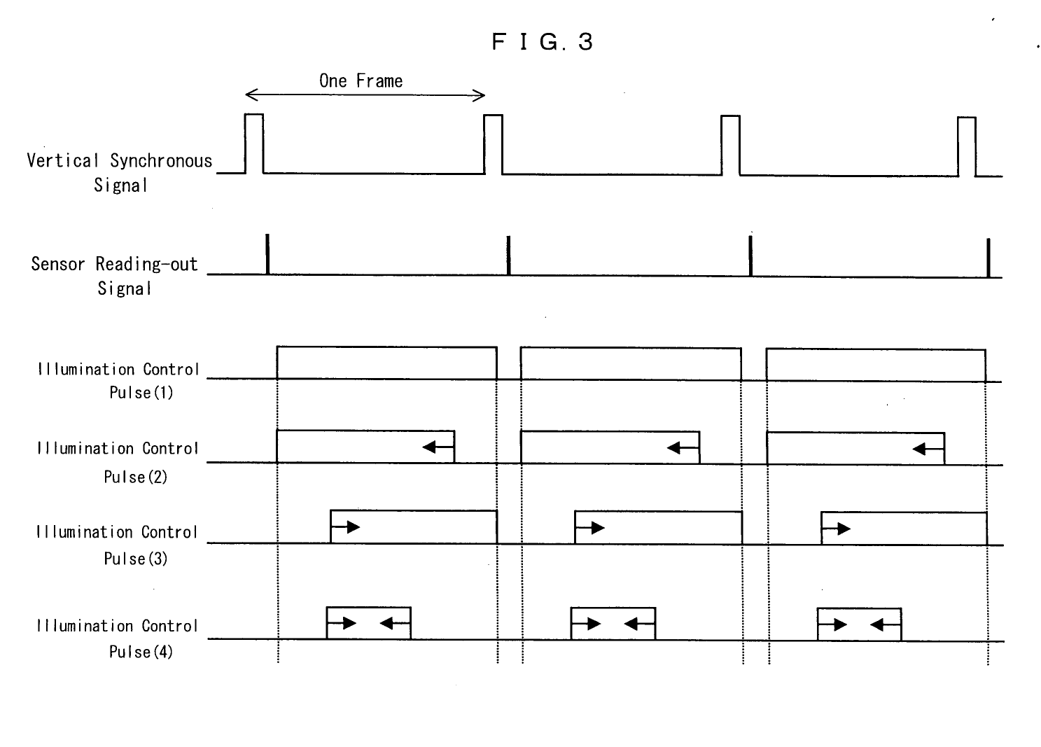

FIG. 3 is a waveform diagram for showing each pulse width (lighting time) of the illumination control pulses (1), (2), (3), (4) of the timing generator 102. The timing generator 102 outputs the sensor reading-out signal to the image sensor 101 by synchronizing with the vertical synchronous signal (VD). The timing generator 102 controls the total illumination light quantity (the illumination light quantity which is the sum of each illumination light quantity of a plurality of frames) of the lighting lamp 201 for an image in a single scene formed with a plurality of frames by controlling the length of the pulse width of the illumination control pulse within one frame period which is the vertical synchronous signal period.

The illumination light quantity of the lighting lamp 201 in a unit time is constant and the total illumination light quantity of the lighting lamp 201 is adjusted by controlling the pulse width of the illumination control pulse, i.e. the lighting time of the lighting lamp 201.

Specifically, the timing generator 102 comprises the register and by appropriately setting the set values of the lighting start timing and the lighting end timing to the register, each position of the leading edge and trailing edge of the illumination control pulse is shifted. As a result, the pulse width of the illumination control pulse is adjusted.

The timing generator 102 changes the pulse width of the illumination control pulse according to the set values of the register by synchronizing with the vertical synchronous signal, and applies the illumination control pulse to the lighting device 108 during the rise time. As a result, the timing for lighting-up and lighting-off of the lighting lamp 201 is changed in accordance with the brightness of the object and the total illumination light quantity of the lighting lamp 201 is adjusted.

There are some methods for adjusting the pulse width of the illumination control pulse. In the illumination control pulse (1), the rise-and-fall corresponds to one frame. In the illumination control pulse (2), the rise timing is fixed and the fall timing is changed. In the illumination control pulse (3), the fall timing is fixed and the rise timing is changed. In the illumination control pulse (4), both the rise timing and the fall timing are changed. The lateral arrows of the illumination control pulses (2), (3), (4) in FIG. 3 indicate which timing (the rise timing or the fall timing) is changed.

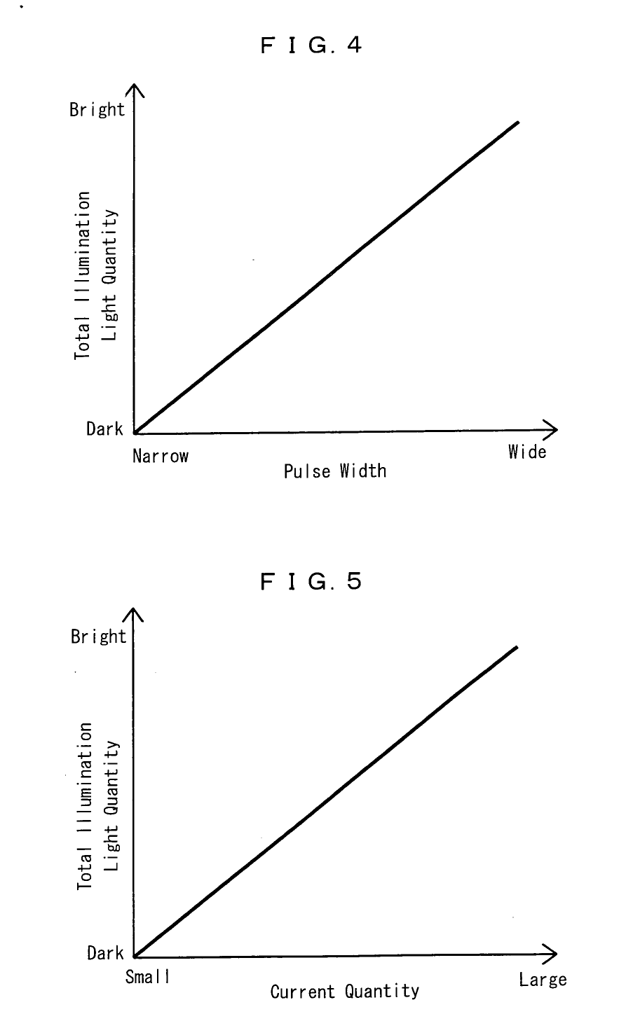

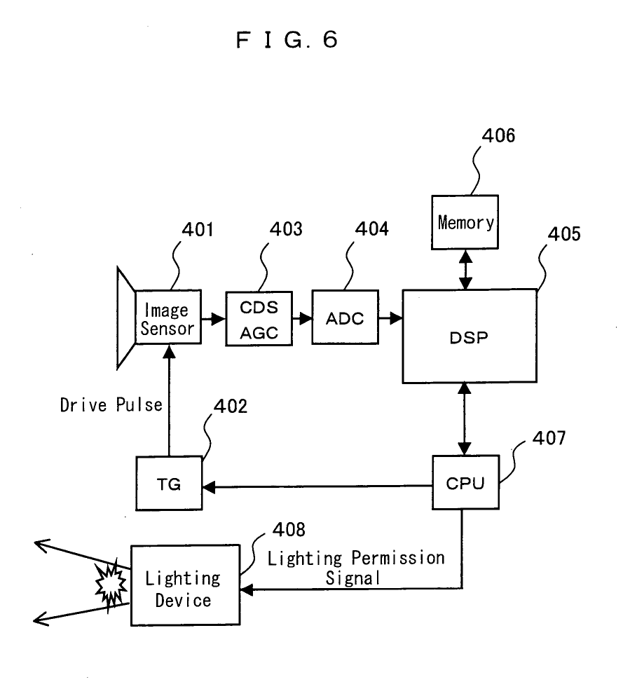

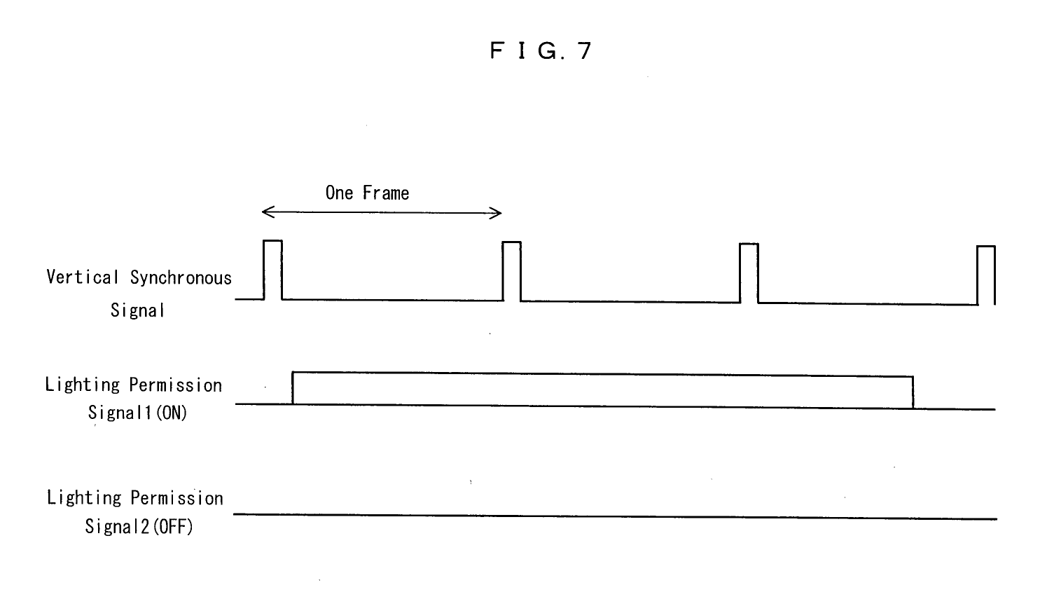

FIG. 4 shows the state where the total illumination light quantity is adjusted in proportion to a change in the pulse width of the illumination control pulse. In the above-mentioned embodiment, adjustment of the total illumination light quantity of the lighting lamp 201 is achieved by the change in the pulse width of the illumination control pulse. Meanwhile, the current quantity to be flown to the lighting lamp 201 is controlled through controlling of a current-quantity variable current generator 202 and the illumination light quantity per unit of time can be controlled.

FIG. 5 shows the state where the total illumination light quantity is adjusted in proportion to a change in the current quantity of the lighting lamp 201. As the lighting lamp 201, a halogen lamp or xenon lamp can be used instead of using high-luminous white LED for lighting object at the time of picking up moving picture. The halogen lamp and the xenon lamp are not driven by the timing generator so that it is necessary to pay attention to control the current quantity to be flown to the lamp itself. By using light emitting diode as the lighting lamp and providing the halogen lamp and the xenon lamp in addition to the light emitting diode, they can be used interchangeably according to the circumstances.

In the embodiment, the brightness of the object is judged by the DSP and performs the feedback control by a command from the CPU for adjusting the illumination light quantity in accordance with the brightness of the object. The luminance can be decreased depending on the brightness of the object. Therefore, in the embodiment, an effect of reducing the power consumption can be expected compared to the related art in which the lighting device is simply turned ON/OFF and lightens always at the maximum luminance when it is ON. In the embodiment, deterioration of S/N ratio is suppressed and smooth moving pictures can be achieved.

While the invention has been described and illustrated in detail, it is to be clearly understood that this is intended be way of illustration and example only and is not to be taken by way of limitation, the spirit and scope of this invention being limited only be the terms of the following claims.

1. A moving picture image pickup device, comprising:
an image sensor for outputting an image signal by photoelectric-converting an incident object light; a lighting device for lighting an object, whose illumination light quantity is adjustable; a signal processing unit for computing luminance of said object based on said image signal; and a control unit for adjusting illumination light quantity of said lighting device by controlling light-up state of said lighting device in accordance with said luminance of said object.

2. The moving picture image pickup device according to claim 1, wherein:
said lighting device starts lighting operation by lighting up in response to an input of an illumination control pulse and also continues said lighting operation while receiving said input of said illumination control pulse; and
said control unit inputs said illumination control pulse to said lighting device and also adjusts said illumination light quantity of said lighting device through controlling pulse width of said illumination control pulse.

3. The moving picture image pickup device according to claim 2, wherein said control unit adjusts lighting start timing and lighting end timing of said lighting device by controlling each position of a leading edge and a trailing edge of said illumination control pulse.

4. The moving picture image pickup device according to claim 2, wherein pulse width of said illumination control pulse is set in one frame in between vertical synchronous signals.

5. The moving picture image pickup device according to claim 1, wherein:
said lighting device comprises a lighting lamp whose illumination light quantity is controlled according to a lamp current quantity, and a current-quantity variable current generator for supplying said lamp current to said lighting lamp; and
said current-quantity variable current generator adjusts illumination light quantity of said lighting lamp by controlling said current quantity supplied to said lighting lamp from said control unit.

6. A moving picture image pickup device, comprising:
an image sensor for outputting a signal in accordance with brightness of an object light; a signal processing unit for calculating actual luminance by performing luminance processing on said signal of said image sensor; a control unit which computes a rise time and pulse width of an illumination control pulse according to a difference between said actual luminance and a target luminance and outputs said illumination control pulse attained by said computation; and a lighting device for lighting an object in response to said illumination control pulse from said control unit.

7. The moving picture image pickup device according to claim 6, wherein said control unit controls to increase light quantity of said lighting device by widening said pulse width of said illumination control pulse when said actual luminance is smaller than said target luminance, while controlling to decrease said light quantity of said lighting device by narrowing said pulse width of said illumination control pulse when said actual luminance is larger than said target luminance.

8. The moving picture image pickup device according to claim 6, wherein said control unit outputs a reading-out signal for said image sensor by synchronizing with a vertical synchronous signal and also controls total illumination light quantity of said lighting device by controlling said pulse width of said illumination control pulse in one frame period which is a period between a vertical synchronous signal and next vertical synchronous signal.

9. The moving picture image pickup device according to claim 6, wherein said lighting device has a constant illumination light quantity in a unit time and total illumination light quantity of said lighting device is controlled by controlling lighting time.

10. The moving picture image pickup device according to claim 6, wherein said control unit comprises a register which has respective positional data of a leading edge and a trailing edge of said illumination control pulse set therein, and said positional set data changes in accordance with a difference between said actual luminance and said target luminance.

11. A moving picture image pickup device, comprising:
a lighting device for performing lighting operation in response to an input of an illumination control pulse; a signal processing unit for calculating luminance of an object based on a signal from an image sensor; and a control unit for adjusting illumination light quantity of said lighting device according to said luminance of said object calculated by said signal processing unit, wherein
said control unit changes an illuminance of said object in real time by performing feedback control on said illumination light quantity of said lighting device through adjusting pulse width of said illumination control pulse in accordance with said luminance of said object.

12. The moving picture image pickup device according to claim 11, wherein said lighting device is a light emitting diode, halogen lamp, or xenon lamp.

13. The moving picture image pickup device according to claim 11, wherein said lighting device is a combination of a light emitting diode and a halogen lamp or a combination of a light emitting diode and a xenon lamp.

14. The moving picture image pickup device according to claim 13, wherein said combinations are interchangeable.
